(19) United States
(12) Patent Application Publication
(10) Pub. No.: US 2006/0022163 A1
(43) Pub. Date: Feb. 2, 2006

(54) Forged aluminum actuator casing for use with fluid valves

(76) Inventors: Paul Richard Anderson, McKinney, TX (US); Joseph David Flaugher, Muscatine, IA (US); James Lyman Griffin JR., Marshalltown, IA (US); Douglas Craig Pfantz, Melbourne, IA (US); Andrew Jared Lukensmeyer, McKinney, TX (US); Daniel Gunder Roper, Lucas, TX (US); Gary Lynn Scott, Marshalltown, IA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/187,123

(22) Filed: Jul. 22, 2005

Related U.S. Application Data
(60) Provisional application No. 60/590,741, filed on Jul. 23, 2004.

(51) Int. Cl. F16K 1/00

(52) U.S. Cl. 251/331

(57) ABSTRACT

Methods and apparatus are disclosed for a substantially non-porous, non-ferrous actuator casing for housing a diaphragm and diaphragm plate for use with a valve. The actuator casing includes first and second portions of forged aluminum and first and second flanges around the perimeters of the first and second portions, respectively. The flanges each further have at least one aperture. Also, there is at least one fastening device that connectively couples the first and second flanges via their respective apertures.

### RELATED APPLICATION

This application claims the benefit of the filing date of U.S. Provisional Application Ser. No. 60/590,741, which was filed on Jul. 23, 2004, the entire disclosure of which is incorporated by reference herein.

### FIELD OF THE DISCLOSURE

The present disclosure relates generally to fluid control devices and, more specifically, to a forged aluminum actuator casing for use with a fluid regulator disposed within a valve body.

### BACKGROUND

Process control plants or systems often employ fluid control devices (e.g., control valves, pressure regulators, etc.) to control the flow and pressure of process fluids such as, for example, liquids, gases, etc. One particularly important fluid valve application involves the distribution and delivery of natural gas. Typically, many portions of a natural gas distribution system are configured to convey or distribute relatively large volumes of gas at relatively high pressure. The relatively high pressure at which the gas is conveyed reduces the flow rates needed to deliver a desired volume of gas and, thus, minimizes the distribution efficiency losses (e.g., pressure drops) due to piping restrictions, valve restrictions, etc.

In addition to being configured to control relatively high-pressure gas, the fluid valves used within a natural gas distribution system must also be configured to minimize or eliminate the escape of natural gas into the surrounding ambient or atmosphere. The escape of natural gas from a fluid valve can result in dangerous conditions such as, for example, explosions, fire, asphyxiation of persons, etc.

Thus, the actuators used to control the flow of natural gas through a fluid valve body must be designed to withstand the high gauge pressures associated with natural gas distribution. In addition, the actuators must be designed to bleed or vent little, if any, gas to the surrounding atmosphere or ambient. As a result, the casings used for the actuators are typically designed to provide high strength and to minimize or eliminate venting or bleeding of gas to atmosphere.

Some actuator casings designed for use with natural gas control devices (e.g., pressure reducing regulators) use stamped or forged steel casing halves. A steel actuator casing provides a relatively high degree of strength and can withstand extremely high gauge pressures over a relatively long service life. Further, steel actuator casings are substantially non-porous and, as a result, are not prone to bleeding or venting of the gas being controlled to atmosphere. While steel actuator casings provide excellent safe, reliable performance for a wide range of control pressures, such steel casings are cost prohibitive and too heavy for many lower pressure gas distribution applications. For instance, the control of natural gas within a natural gas distribution system typically involves lower pressures nearer to the points of delivery or usage.

Cast aluminum actuator casings are typically used to implement the fluid valves that control lower pressure gas within a gas distribution system. Cast aluminum casings are relatively inexpensive but are typically porous and may have voids within the walls of the casings. The porosity and voids require a higher safety factor (i.e., the ratio of maximum or burst pressure to rated operating pressure) to be used and, thus, greater wall thickness. Some cast aluminum actuator casing designs require a safety factor as high as four to one. The greater wall thickness needed results in the use of more material, which increases both the weight and the cost of the cast aluminum casings.

Additionally, the porosity of the cast aluminum casings requires the casing halves to be sealed via a secondary process. One known process involves chemically impregnating the cast aluminum casing halves with, for example, an adhesive or sealant. However, such secondary processing steps are costly and prone to some degree of yield loss (i.e., some parts may not be adequately sealed to be used in a shippable valve).

### BRIEF DESCRIPTION OF THE DRAWINGS

FIG. 1 depicts an example forged aluminum actuator casing for use with fluid valves.

FIG. 2 is a cross-sectional view of an example gas valve that uses the example actuator casing of FIG. 1.

FIG. 3 depicts the upper actuator casing half of the example forged aluminum actuator casing of FIG. 1.

FIG. 4 is a detailed plan view of the upper actuator casing half of FIG. 3.

FIG. 5 is a detailed cross-sectional view of the upper actuator casing half of FIG. 3.

FIG. 6 depicts the lower actuator casing half of the example forged aluminum actuator casing of FIG. 1

FIG. 7 is a detailed plan view of the lower actuator casing half of FIG. 6.

FIG. 8 is a detailed cross-sectional view of the lower actuator casing half of FIG. 6.

### DETAILED DESCRIPTION

The example forged aluminum actuator casing described herein provides a significantly lower weight part in comparison to conventional cast aluminum actuator casings. In particular, the material and processing techniques used to fabricate the example forged aluminum actuator casing described herein results in a casing that is substantially non-porous and non-ferrous and which is substantially more ductile that cast aluminum actuator casings. The substantial ductility of the example forged aluminum actuator casing described herein (as well and the non-porous nature of the example casing) significantly reduces the design safety factor (i.e., the ratio of the maximum safe pressure to rated operating pressure of the actuator casing). For example, a safety factor of about four to one is typically used when designing cast aluminum actuator casings, whereas with the example forged aluminum actuator casing described herein, a safety factor of about one and a half to one may be used.

The reduced safety factor associated with the example forged aluminum actuator casing described herein enables the production of an aluminum casing having significantly reduced wall thicknesses in comparison to cast aluminum casings. The reduced wall thicknesses, in turn, result in an actuator casing composed of significantly less material (and which weighs significantly less) than a comparable performance cast aluminum actuator casing. In addition to being lighter weight in comparison to cast aluminum actuator casings, the forged aluminum actuator casing described herein is substantially non-porous and, thus, a secondary sealing process (such as those conventionally used with known cast aluminum actuator casings) is not needed.

Further, the example forged aluminum actuator casing described herein may be fabricated using a material complying with The American Society of Mechanical Engineers (ASME) standard SB247 CL.T4, which may be formed from Unified Numbering System for Metal and Alloys (UNS) standard A92014 aluminum. The use of such an ASME compliant material can greatly simplify the approval process for applications using the example forged aluminum actuator in many world markets. For example, the aforementioned material (i.e., ASME SB247 CL.T4) is compliant with the ASME boiler code, which greatly simplifies the approval process for the example forged aluminum actuator casing described herein.

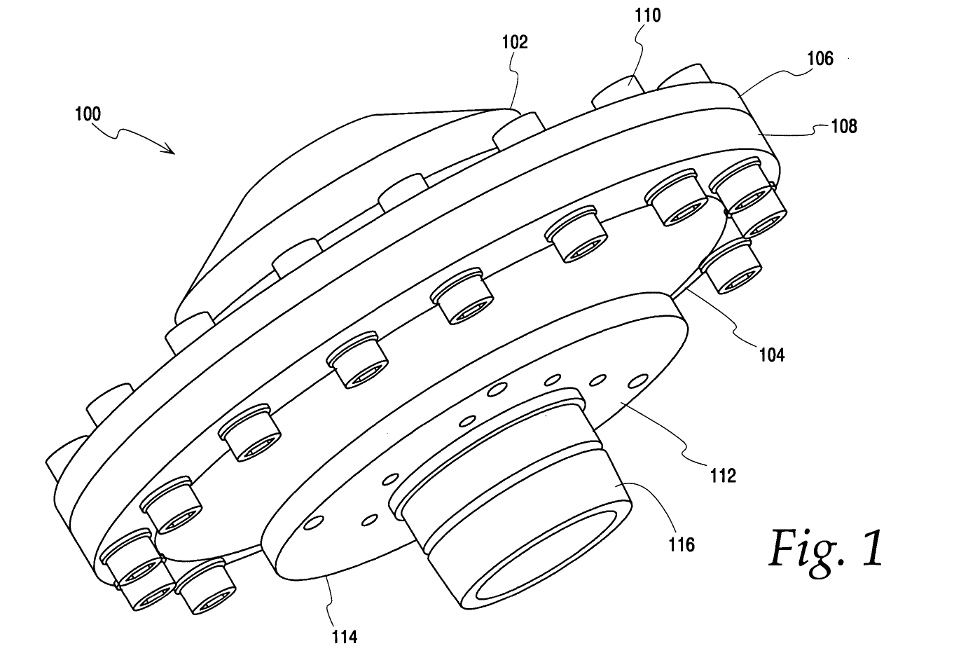

Now turning to FIG. 1, an example forged aluminum actuator casing 100 for use with fluid valves is shown. The example forged aluminum actuator casing 100 includes an upper casing half 102 and a lower casing half 104. The terms “upper” and “lower” are merely used to distinguish the first and second halves of the actuator casing 100 and are not intended to be restrictive of the manner in which the example actuator casing 100 is used. For example, the actuator casing 100 may be field mounted in any desired orientation to satisfy the needs of a particular application and the casing halves 102 and 104 may still be referred to as “upper” and “lower,” respectively.

The casing halves 102 and 104 are sealingly coupled at respective flange portions 106 and 108 via fasteners 110. The fasteners 110 may be any suitable fastening mechanism such as, for example, nuts, bolts, washers, etc.

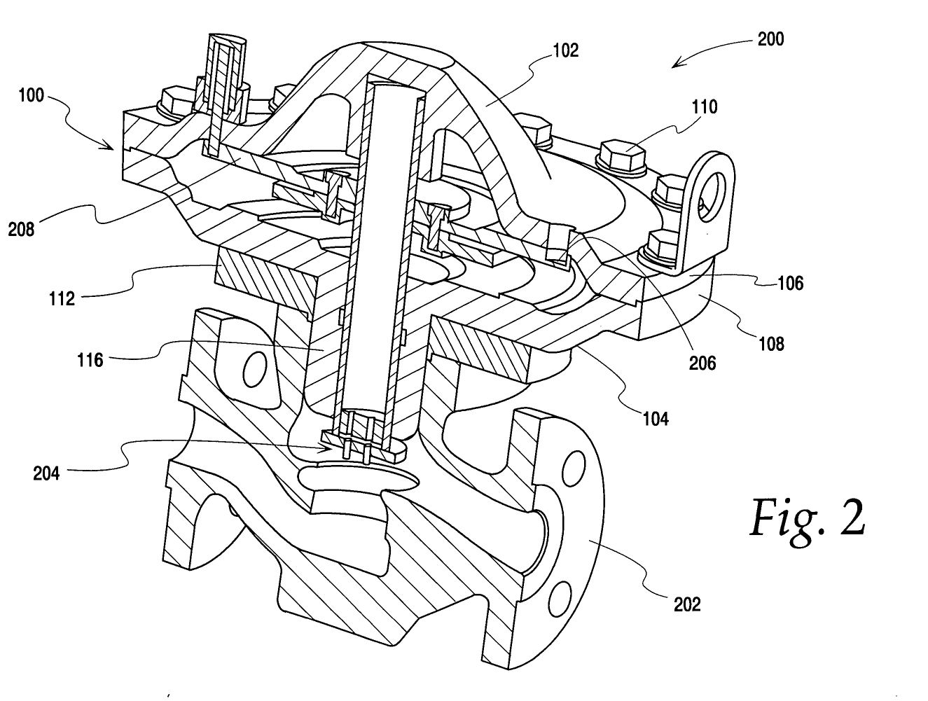

The lower casing 104 includes a mounting flange portion 112 that enables the actuator casing 100 to be fixed (e.g., bolted) to a valve body as depicted in FIG. 2. The mounting flange portion 112 may include a pattern of holes or other apertures 114 that enable the actuator casing 100 to be fixed to any one of a plurality of different valve bodies. The lower casing 104 also includes a hub portion 116 which, as shown in greater detail in FIG. 2, serves to align and couple the actuator casing 100 to a valve body, guide the operation of the valve trim, facilitate the tight sealing of the actuator casing 100 to a valve body, etc.

FIG. 2 is a cross-sectional view of an example gas valve 200 that uses the example actuator casing 100 of FIG. 1. FIG. 2 generally depicts an example relationship between the example actuator casing 100 and a valve body 202 and valve trim 204. The valve body 202 and valve trim 204 may be any known or other suitable valve body and trim and, thus, are not described further herein. As depicted in FIG. 2, a diaphragm 206 and a diaphragm plate 208 may be disposed within the actuator casing 100.

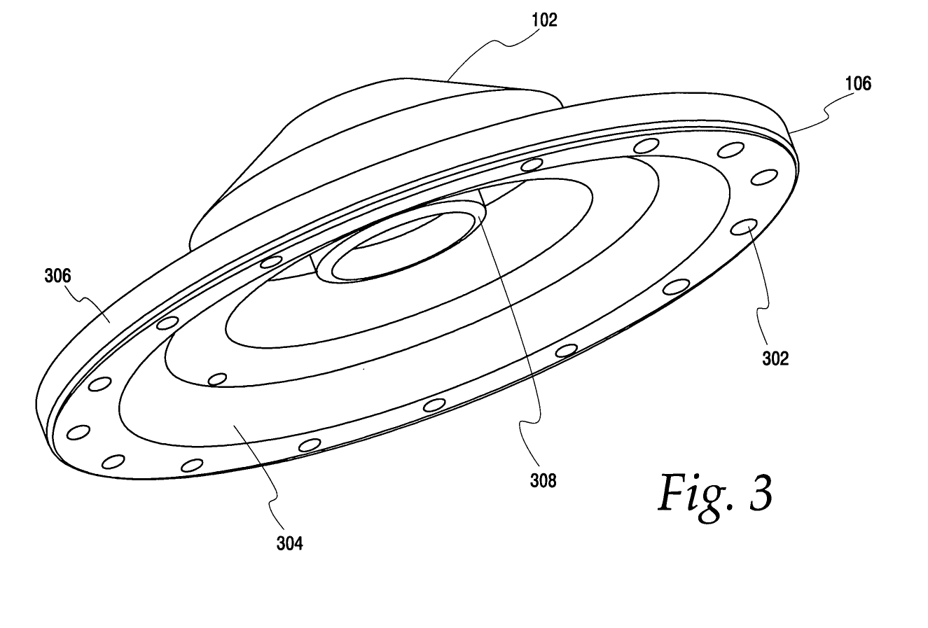

FIG. 3 depicts the upper actuator casing half 102 of the example forged aluminum actuator 100 casing of FIG. 1. As shown in FIG. 3, the upper actuator casing half 102 includes a plurality of apertures 302 that are circumferentially spaced about the flange portion 106. A first angled wall portion 304 extends between the flange portion 106 and a shoulder portion 306. The shoulder portion 306 may be configured to function as a mechanical support or stop against which the diaphragm plate 208 and/or the diaphragm 206 may be supported and/or stopped. The depth and angle of the wall portion 304 may be selected to achieve a desired amount of diaphragm travel and/or to control the stresses applied to the diaphragm 206 during use of the actuator 100 (FIG. 1). The upper casing half 102 also includes a hub 308, which may be used to guide the operation the valve trim 204 and/or a bias spring (not shown).

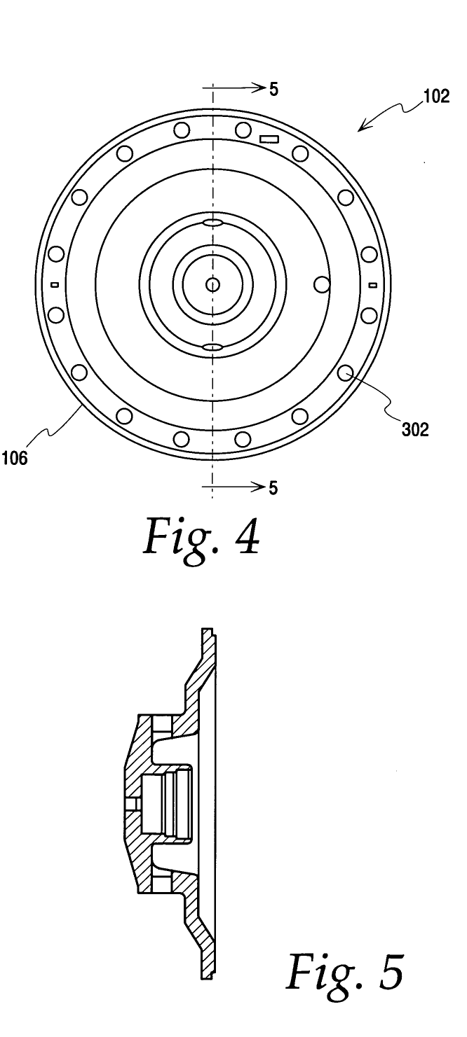

FIG. 4 is a detailed plan view of the upper actuator casing half 102 of FIG. 3 and FIG. 5 is a detailed cross-sectional view of the upper actuator casing half 102 of FIG. 3.

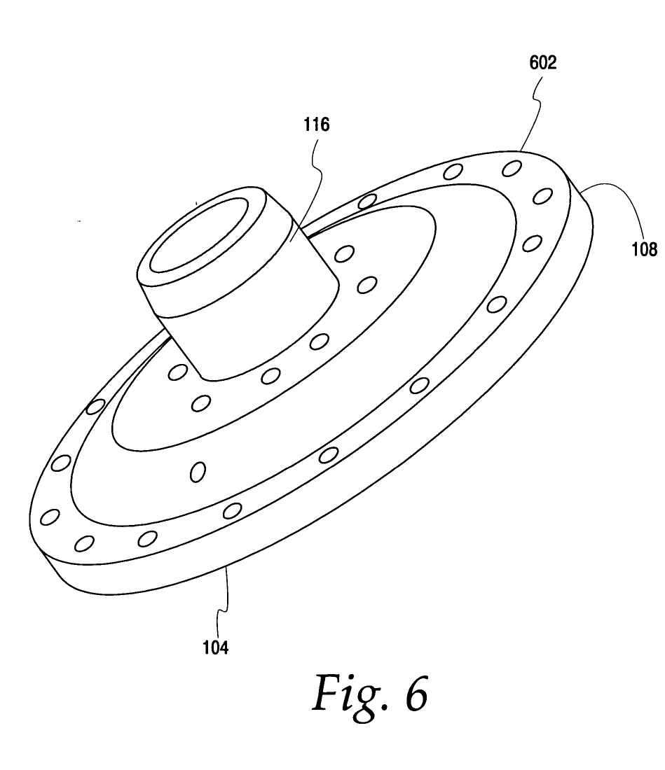

FIG. 6 depicts the lower actuator casing half 104 of the example forged aluminum actuator casing 100 of FIG. 1. The lower actuator casing half 104 includes a plurality of apertures 602 configured to receive the fasteners 110 as shown in FIG. 1.

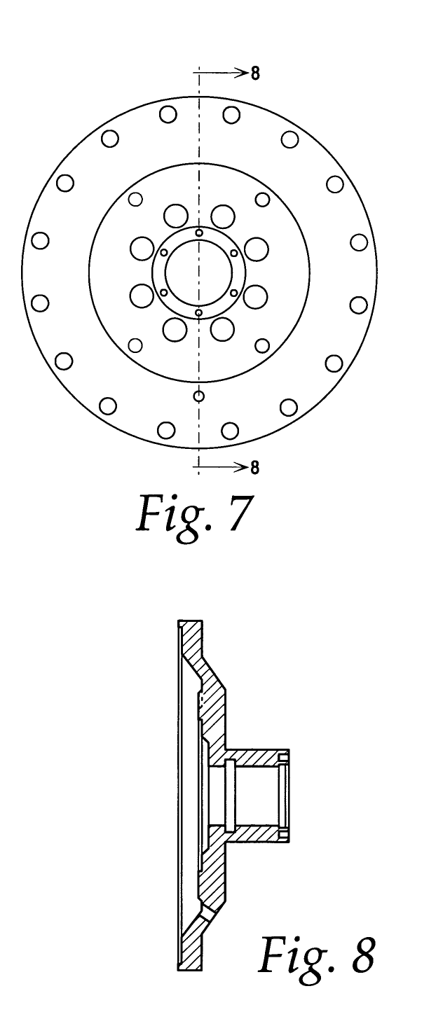

FIG. 7 is a detailed plan view of the lower actuator casing half 104 of FIG. 6 and FIG. 8 is a detailed cross-sectional view of the lower actuator casing half 104 of FIG. 6.

In some applications such as, for example, pit applications, the actuator casing halves 102 and 104 may be anodized to protect the casing halves 102 and 104 from corrosion and the like.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A substantially non-porous, non-ferrous actuator casing for use with a valve, the actuator casing comprising:
a first forged aluminum casing portion having a first flange around a perimeter of the first portion; and
a second forged aluminum casing portion having a second flange around a perimeter of the second portion and a plurality of apertures in each of the first and second flanges, wherein at least some of the apertures in the first flange correspond to at least some of the apertures in the second flange, and wherein the corresponding apertures are configured to receive fasteners to couple the first and second actuator casing portions to form the actuator casing.

2. An actuator casing as defined in claim 1, wherein the first casing portion further includes a first hub of forged aluminum and the second casing portion further includes a second hub of forged aluminum.

3. An actuator casing as defined in claim 2, wherein the hubs are configured for one of aligning the actuator casing with to a valve body, guiding the operation of a valve trim, or facilitating the tight sealing of the the actuator casing to a valve body.

4. An actuator casing as defined in claim 1, wherein the first and second casing portions are configured to be sealingly coupled.

5. An actuator casing as defined in claim 1, wherein the first casing portion has a back portion and an angled portion.

6. An actuator casing as defined in claim 5, wherein the back portion functions as a stop for a diaphragm.

7. An actuator casing as defined in claim 5, wherein the angled portion is sized and angled to achieve a desired amount of diaphragm movement.

8. An actuator casing as defined in claim 1, wherein the first and second casing portions are substantially non-porous.

9. An actuator casing as defined in claim 1, wherein the forged aluminum casing portions are made of a forged aluminum that complies with the American Society of Mechanical Engineers (ASME) standard SB247 CL.T4.

10. A substantially non-porous, non-ferrous actuator casing for use with a valve, the actuator casing comprising:
a first aluminum casing portion having a first flange around the perimeter of the first aluminum casing portion;
a second aluminum casing portion having a second flange around the perimeter of the second aluminum casing portion;
at least one aperture in each of the first and second flanges; and
at least one fastening device that couples the first and second flanges via their respective apertures so that when the aluminum casing portions are coupled the actuator casing has a safety factor of less than about two.

11. An actuator casing as defined in claim 10, wherein the first aluminum casing portion and the second aluminum casing portion are made of forged aluminum.

12. An actuator casing as defined in claim 11, wherein the forged aluminum complies with the American Society of Mechanical Engineers (ASME) standard SB247 CL.T4.

13. An actuator casing as defined in claim 11, wherein the aluminum casing portions include hubs to align the aluminum casing portions with other parts of the valve.

14. An actuator casing as defined in claim 10, wherein the first and second aluminum casing portions are sealingly coupled.

15. An actuator casing as defined in claim 10, wherein the first casing portion has a back portion and an angled portion.

16. An actuator casing as defined in claim 15, wherein the back portion functions as a stop for a diaphragm.

17. An actuator casing as defined in claim 15, wherein the angled portion is sized and angled to achieve a desired amount of diaphragm movement.

18. An actuator casing for housing a diaphragm and diaphragm plate for use with a valve, the actuator casing comprising:
a first portion;
a first flange around a perimeter of the first portion;
a second portion;
a second flange around a perimeter of the second portion;
at least one aperture in each of the first and second flanges;
at least one fastening device that couples the first and second flanges via their respective apertures; and
wherein the shape and thickness of the first and second portions are configured to closely profile the diaphragm and diaphragm plate.

19. As actuator casing as defined in claim 18, wherein the first and second portions and the first and second flanges have a thickness of and are made of a material that, when the casing is assembled, provides the casing a safety factor of about one and a half to one.

20. An actuator casing as defined in claim 18, wherein the first portion further includes a first hub, the second portion further includes a second hub, and the first and second hubs are made of the same materials as the portions and flanges.

21. An actuator casing as defined in claim 20, wherein the hubs are configured to facilitate alignment of the casing with other parts of the valve.

22. An actuator casing as defined in claim 18, wherein the first and second portions are sealingly coupled.

23. An actuator casing as defined in claim 18, wherein the first portion has a back portion and an angled portion.

24. An actuator casing as defined in claim 23, wherein the back portion functions as a stop for the diaphragm.

25. An actuator casing as defined in claim 23, wherein the angled portion is sized and angled to achieve a desired amount of diaphragm movement.
